(19) United States
(12) Patent Application Publication
(10) Pub. No.: US 2011/0264596 A1
(43) Pub. Date: Oct. 27, 2011

(54) SOCIAL REFERRAL NETWORKS

(76) Inventor: Wayne Joseph Shifflett, Savannah, GA (US)

(21) Appl. No.: 13/081,580

(22) Filed: Apr. 7, 2011

Related U.S. Application Data
(60) Provisional application No. 61/328,100, filed on Apr. 26, 2010.

(51) Int. Cl. G06Q 99/00

(52) U.S. Cl. 705/319

(57) ABSTRACT

Techniques are disclosed for maintaining a personalized referral network for each of multiple users. A user may browse businesses and/or professional services recommended by other users of the personalized referral network for the user. The user may also manage the personalized referral network to control what recommendations appear in a personalized recommendations feed for the user. Advantageously, the user may more conveniently receive recommendations that are responsive to the needs of the user.

### CROSS-REFERENCE TO RELATED APPLICATIONS

This application claims benefit of U.S. provisional patent application Ser. No. 61/328,100, filed on Apr. 26, 2010.

### BACKGROUND

Online social networking is becoming increasingly popular as a way for users to interact over the Internet. A social network may include a representation of each user (often in the form of a profile for the respective user), a representation of social relations of each user, and a variety of additional services. The additional services may allow each user to share ideas, interests, activities, and events within the social network of the respective user. The user may participate in online social networking via a social networking application. A social networking application can be a web-based application that allows users to create and publish shared content on personal web pages. Shared content may include digital media that is accessible by visitors to the personal web page. The digital media may include text, hyperlinks, images, video, audio, etc. The user who owns the shared content may determine which other users may access the shared content.

### SUMMARY

One embodiment of the invention includes a method that may generally include providing a social business referral service that includes asymmetric relationships between users. Providing the social business referral service may include receiving a request from a first user to be notified of any business entity referred by a second user; and storing, responsive to the request and in a referral network associated with the first user, an indication to notify the first user of business entities referred by the second user; and receiving, from the second user, an indication of a referred business entity; and notifying the first user that the second user has referred the business entity, on the basis of the stored indication to notify the first user of business entities referred by the second user.

Another embodiment of the invention includes a computer-readable storage medium containing a program which, when executed, performs an operation. The operation may generally include providing a social business referral service that includes asymmetric relationships between users. Providing the social business referral service may include receiving a request from a first user to be notified of any business entity referred by a second user; and storing, responsive to the request and in a referral network associated with the first user, an indication to notify the first user of business entities referred by the second user; and receiving, from the second user, an indication of a referred business entity; and notifying the first user that the second user has referred the business entity, on the basis of the stored indication to notify the first user of business entities referred by the second user.

Another embodiment of the invention includes a system that may include one or more computer processors and a memory containing a program which, when executed by the one or more computer processors, performs an operation. The operation may generally include providing a social business referral service that includes asymmetric relationships between users. Providing the social business referral service may include receiving a request from a first user to be notified of any business entity referred by a second user; and storing, responsive to the request and in a referral network associated with the first user, an indication to notify the first user of business entities referred by the second user; and receiving, from the second user, an indication of a referred business entity; and notifying the first user that the second user has referred the business entity, on the basis of the stored indication to notify the first user of business entities referred by the second user.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for providing personalized referral networks, according to one embodiment of the invention.

FIGS. 2A-2H illustrate networked computers for an application that provides personalized referral networks, according to one embodiment of the invention.

FIG. 3 illustrates a user interface screen of the application, according to one embodiment of the invention.

FIGS. 4A-4N illustrate a collection of exemplary UI screens generated by the application, according to one embodiment of the invention.

FIG. 5 is a flow diagram depicting a method for sending a recommendation from a personalized referral network to a user, according to one embodiment of the invention.

FIG. 6 is a flow diagram depicting a method for generating a recommendation feed for a user, according to one embodiment of the invention.

### DETAILED DESCRIPTION

Embodiments of the invention provide techniques for maintaining a personalized referral network for a user. The user may browse businesses and/or professional services recommended by other users of the personalized referral network. The user may also manage a personalized referral network generated for that user. For example, the user may specify users to add to their personalized referral network. The personalized referral network may be symmetrical or asymmetrical. In a symmetrical network, relationships between users are bidirectional—e.g., when user A adds user B to the personalized referral network of user A, user A is also added to the personalized referral network of user B. Thus, in a symmetrical network, two related users may browse businesses and/or professional services recommended by each other.

In contrast, in an asymmetrical network, relationships between users are unidirectional—e.g., when user A adds user B to their personalized referral network, user A is not necessarily added to the personalized referral network of user B (i.e., merely by virtue of user A adding user B). Thus, in an asymmetrical network, there can be two users for which only one of the users may browse businesses and/or professional services recommended by the other. While embodiments are described with reference to an asymmetrical network, those skilled in the art will recognize that the techniques disclosed herein may be adapted to support other types of networks, such as symmetrical networks.

One embodiment provides an application for social networking. The application may maintain the personalized referral network for the user. The personalized referral network may include a first list of users “following” the user—i.e., a list of other users who have previously specified a desire to view recommendations from the user. The personalized referral network may also include a second list of users “followed by” the user—a list of other users from whom the user has previously specified a desire to view recommendations. The application may receive a new recommendation (from any user). The application may determine which users can view the new recommendation. The application may also allow users to filter recommendations based on additional constraints such as keywords, geographic location, etc. Advantageously, by using the application to manage a personalized referral network, a user may more conveniently access recommendations for businesses and/or professional services.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

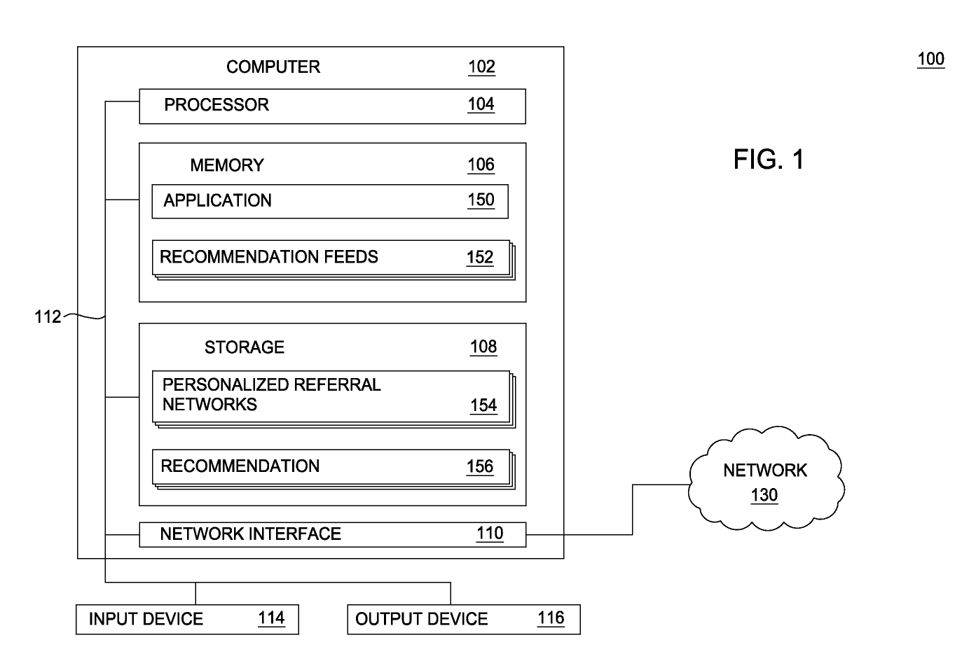

FIG. 1 is a block diagram illustrating a system 100 for providing personalized referral networks, according to one embodiment of the invention. The networked system 100 includes a computer 102. The computer 102 may be connected to other computers via the network 130. In general, the network 130 may be a telecommunications network and/or a wide area network (WAN). In a particular embodiment, the network 130 is the Internet.

The computer 102 generally includes a processor 104 connected via a bus 112 to a memory 106, a network interface device 110, a storage 108, an input device 114, and an output device 116. The computer 102 is generally under the control of an operating system (not shown). Examples of operating systems include UNIX, versions of the Microsoft Windows® operating system, and distributions of the Linux® operating system. (Note: Linux is at trademark of Linus Torvalds in the United States and other countries.) More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 110 may be any type of network communications device allowing the computer 102 to communicate with other computers via the network 130.

The storage 108 may be a hard disk drive storage device. Although the storage 108 is shown as a single unit, the storage 108 may be a combination of fixed and/or removable storage devices, such as fixed disc drives, solid state drives, floppy disc drives, tape drives, removable memory cards, or optical storage. The memory 106 and the storage 108 may be part of one virtual address space spanning multiple primary and secondary storage devices.

The input device 114 may be any device for providing input to the computer 102. For example, a keyboard and/or mouse may be used. The output device 116 may be any device for providing output to a user of the computer 102. For example, the output device 116 may be any conventional display screen or set of speakers, along with their respective interface cards. Although shown separately from the input device 114, the output device 116 and input device 114 may be combined. For example, a display screen with an integrated touch-screen may be used.

As shown, the memory 106 of the computer 102 includes an application 150 and recommendation feeds 152. The storage 108 of the computer 102 includes personalized referral networks 154 and recommendations 156. In one embodiment, a user of the application 150 may access and manage a personalized referral network 154 via the application 150. The application 150 may receive recommendations 154 from the user and/or from other users. The application 150 may determine which of the recommendations 154 each user may view, based on the personalized referral network 154 for the respective user.

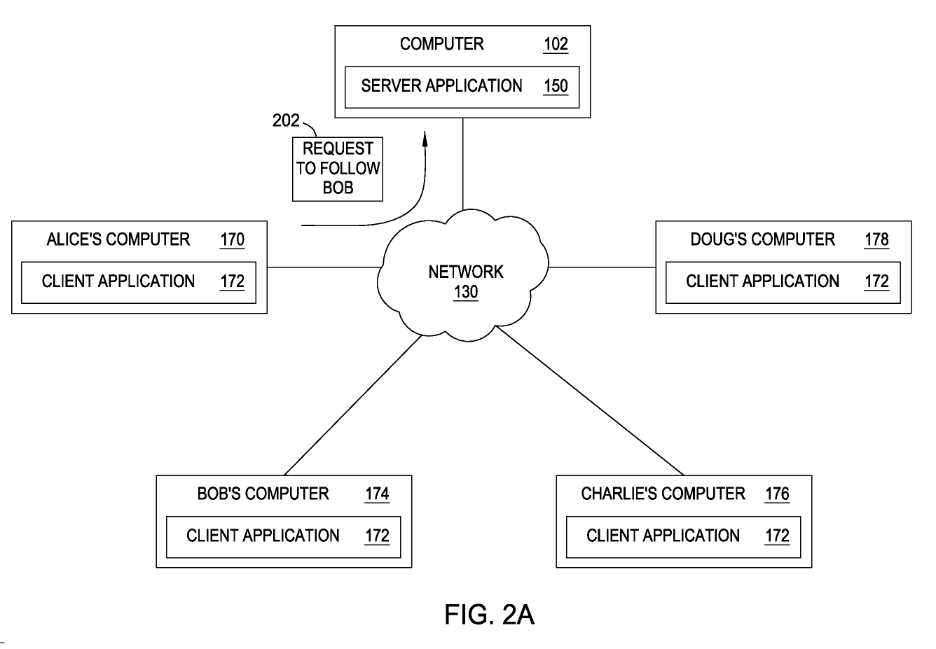

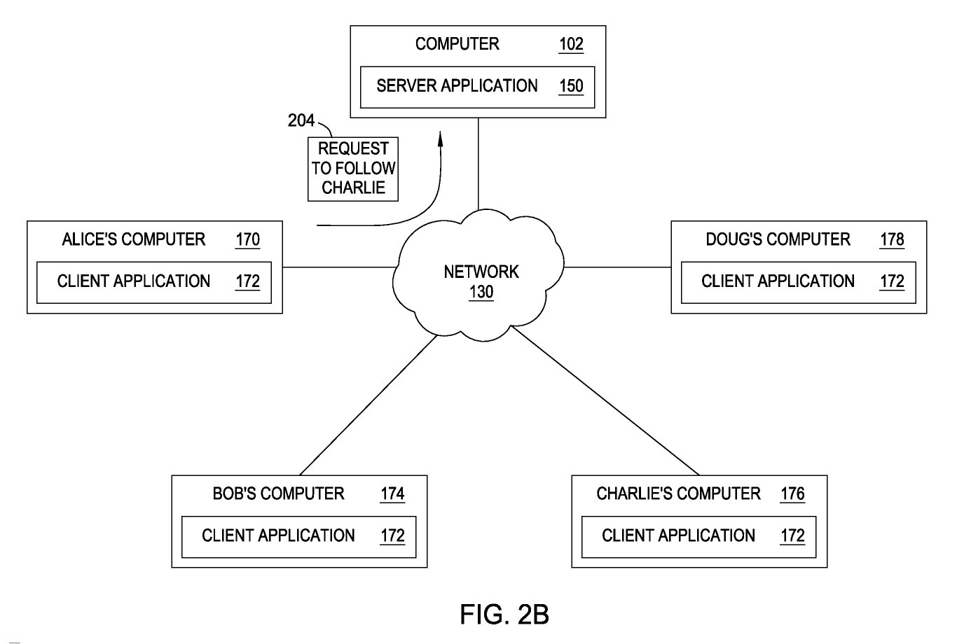

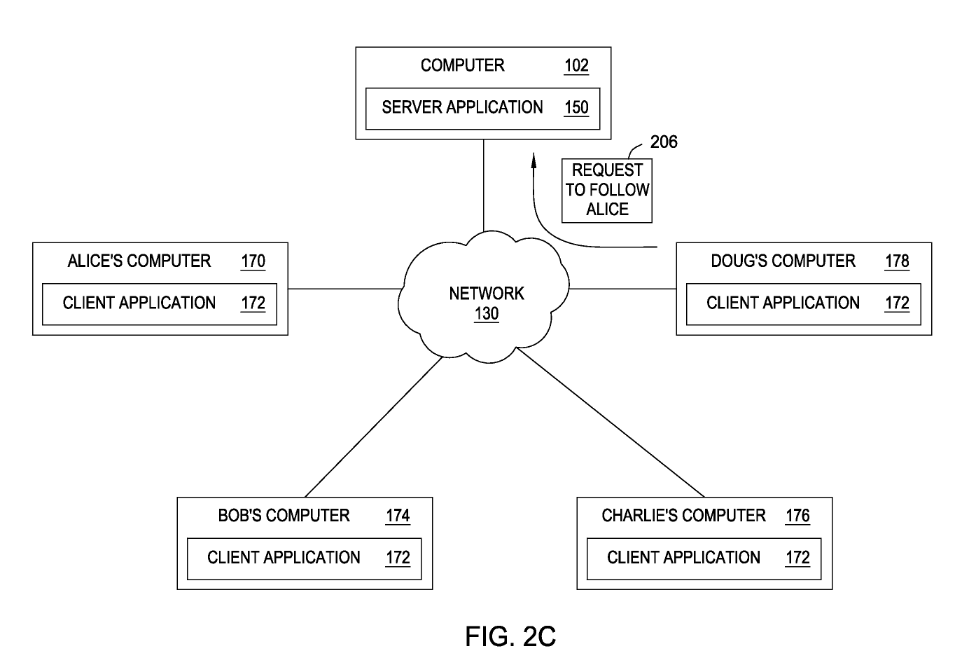

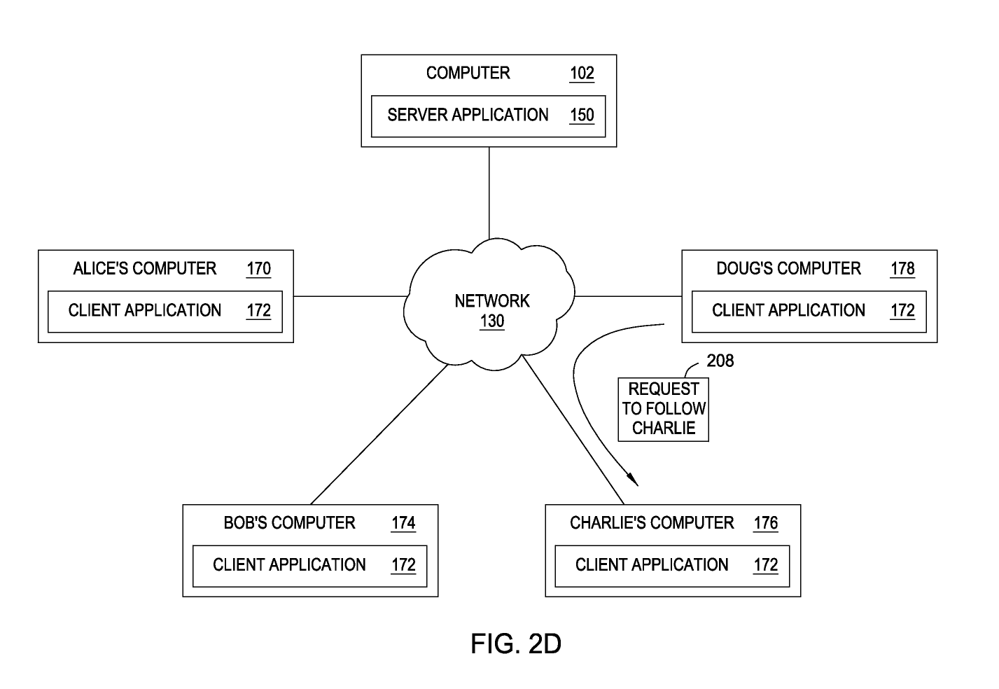

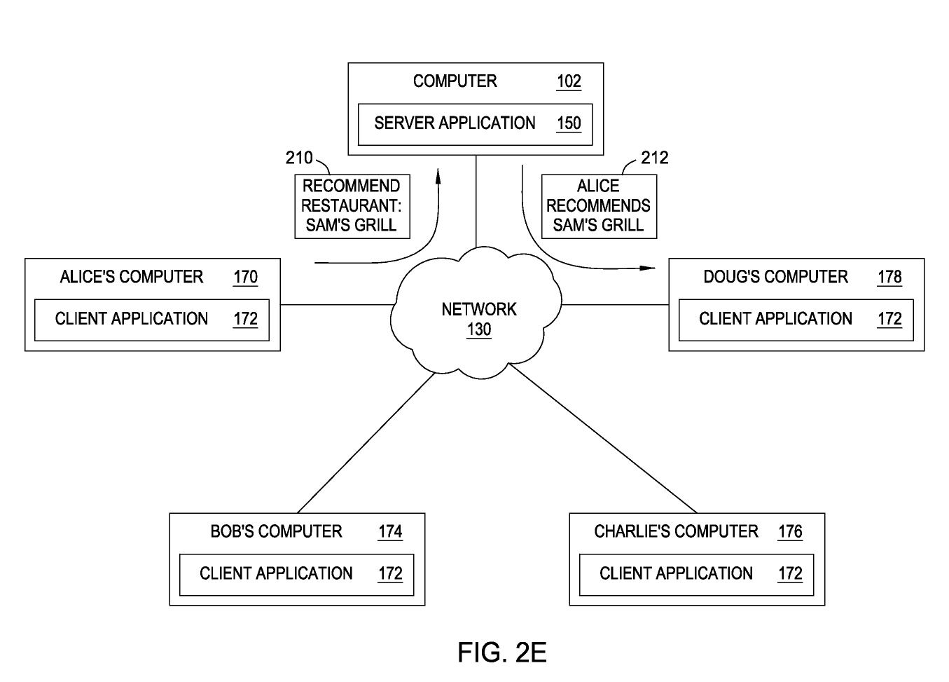

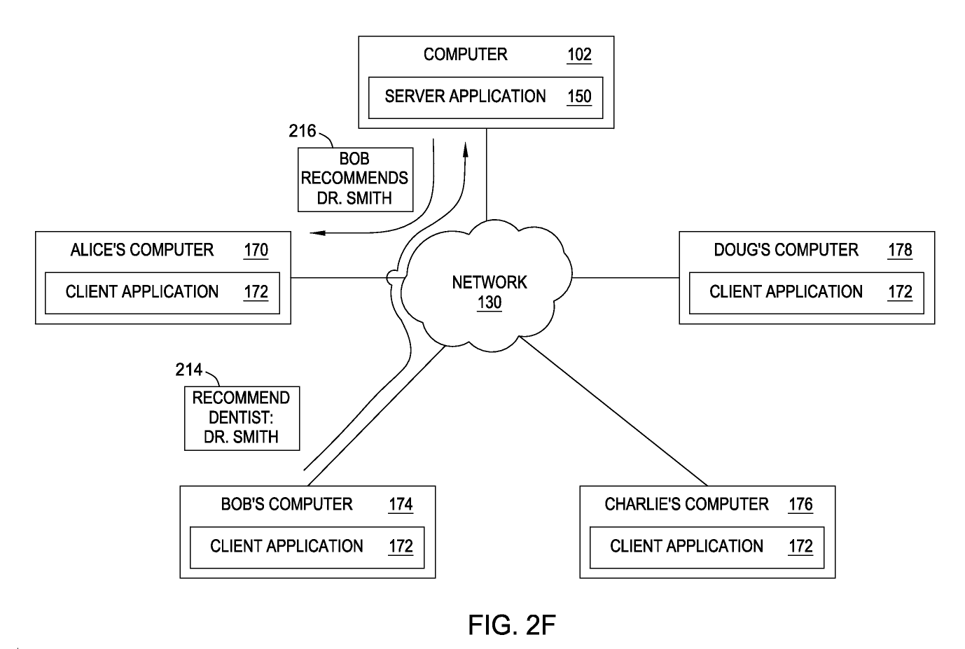

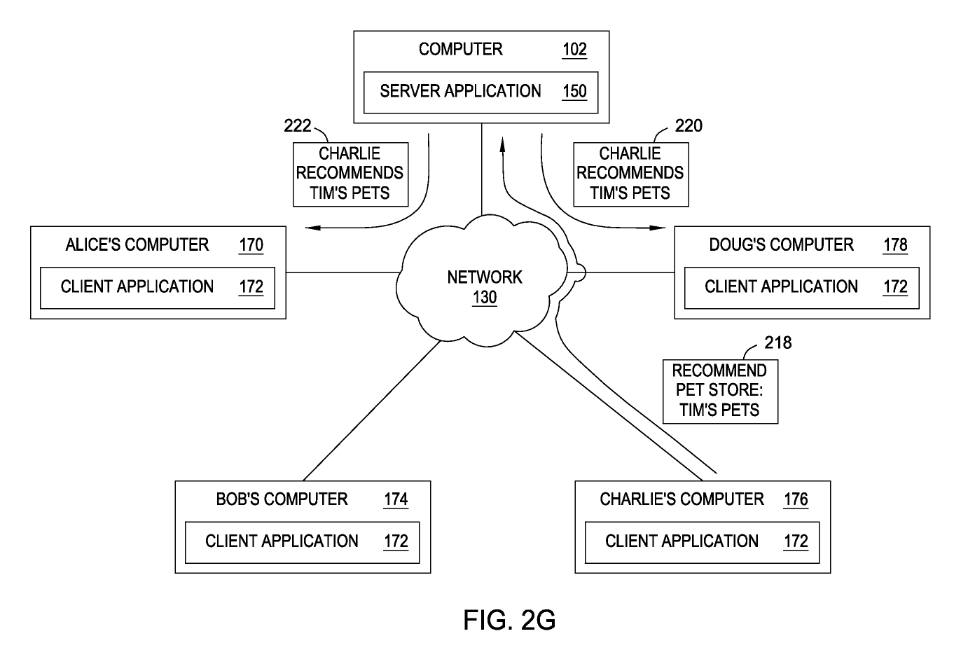

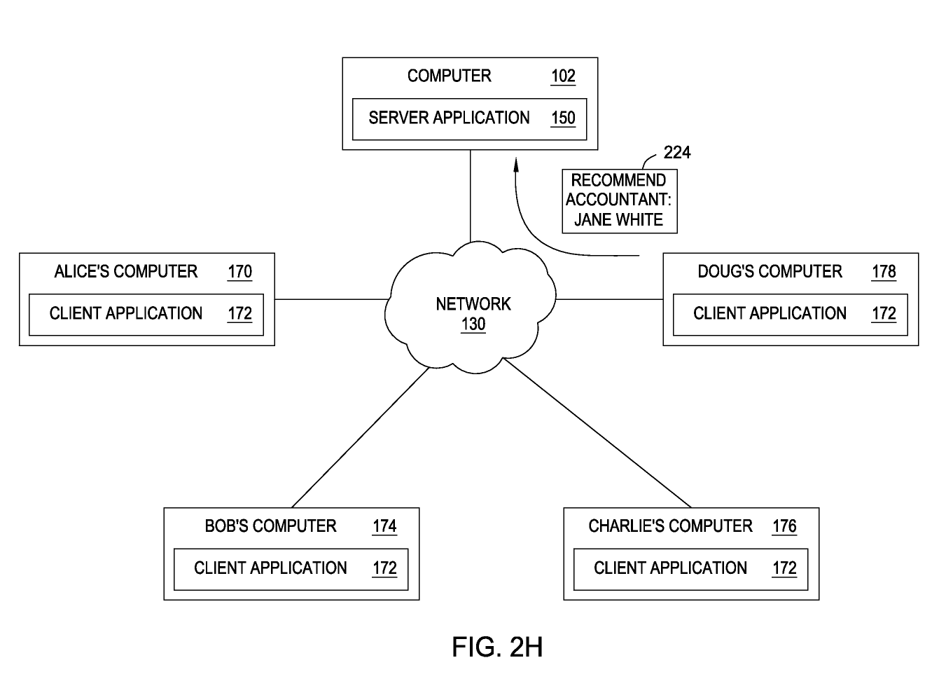

In one embodiment, the application 150 may be a server application that communicates with a client application to provide a personalized referral network 154 for a user. FIGS. 2A-2H illustrate computers connected to the network 130 to access the application 150, according to one embodiment of the invention. As shown in FIG. 2A, the server application 150 executes on the computer 102. Client application 172 executes on the computer 170, 174, 176, 178 of each user. In one embodiment, the server application 150 is a web application and the client application 172 is a web browser that accesses the web application—e.g., via a Uniform Resource Identifier (URI) associated with the web application (such as http://referred.com/). As is known, a URI is a string of characters used to identify a name or a resource on the Internet.

In one embodiment, the application 150 may receive a request 202 to follow another user. For sake of discussion, assume a user named Alice interacts with the application 250 to follow a user named Bob. In response, the application 150 updates the personalized referral network of Alice to include Bob. For example, the application 150 may add a user identifier associated with Bob to a list of user identifiers of users followed by Alice. The user identifier may be assigned by the application 150 to each user to unique identify the respective user. The application 150 may also receive requests from Alice to follow yet other users. For example, as shown in FIG. 2B, the application 150 may receive a request 204 from Alice to follow Charlie. In response, the application 150 may update the personalized referral network of Alice to include Charlie.

In one embodiment, the application 150 may maintain, for each user, a personalized referral network for the respective user. That is, the application 150 may maintain multiple personalized referral networks—each of which is specific to a particular user. For instance, as shown in FIG. 2C, the application 150 may receive a request 206 from Doug to follow Alice. In response, the application 150 may update the personalized referral network of Doug to include Alice. The application may also receive requests to follow additional users. For example, as shown in FIG. 2D, the application 150 receives a request 208 from Doug to follow Charlie. In response, the application 150 updates the personalized referral network of Doug to include Charlie.

In one embodiment, the application 150 may receive a recommendation of a business or professional service. For example, as shown in FIG. 2E, the application 150 receives a recommendation 210 of a restaurant named “Sam's Grill” from Alice. Because Doug has previously specified to follow Alice, the application 150 may notify Doug of the recommendation 210. For example, responsive to a subsequent request from Doug for a personalized referrals feed, the application 150 may generate the personalized referrals feed (that includes the recommendation 210) and send the personalized referrals feed to Doug. In contrast, the application 150 does not notify a user who has not specified to follow Alice (e.g., Charlie). That is, responsive to a subsequent request Charlie for a personalized referrals feed, the application 150 may generate the personalized referrals feed (that does not include the recommendation 210) and send it to Charlie. In one embodiment, the application 150 also allows Charlie to access the recommendation 210 in another manner (i.e., other than via the personalized referrals feed). For example, Charlie may filter a list of all recommendations stored by the application 150 to discover the recommendation 210. Nevertheless, the personalized referrals feed may provide a convenient way to view recommendations from trusted friends, family members, and/or acquaintances, without having to sift through a list of all recommendations stored by the application 150 for all users.

Further, the application 150 may notify Doug of the recommendation 210 in a variety of ways. Suppose, e.g., the application 150 had previously sent a personalized referrals feed—that did not include the recommendation 210—to the client application 172 for Doug. Suppose further that the client application 172 has rendered the personalized referrals feed for display to Doug. In this case, the application 150 may transmit the recommendation 210 (rather than an updated personalized referrals feed) to the client application 172 for Doug. The client application 150 may render the recommendation 210 for display in the personalized referrals feed—without having to refresh or re-render the personalized referrals feed. For example, the server application 150 and the client application 172 may use interactive web technologies to display a newly received recommendation on an already-rendered referrals feed, without having to refresh the entire referrals feed. One example of an interactive web technology is asynchronous JavaScript and XML (Ajax). Ajax refers to a group of interrelated web development techniques for creating interactive web applications. Using Ajax, web applications can retrieve data from the server asynchronously in the background, without interfering with the display and behavior of the existing page. Of course, other interactive web technologies may be used in accordance with the techniques disclosed herein, without departing from the scope of the invention.

The application 150 may notify Doug of the recommendation 210 in still other ways. For example, the application 150 may send an email to an email address for Doug (e.g., that is stored in the profile of Doug). Alternatively, the application 150 may cause a dialog box to be displayed on the computer 178 of Doug. The dialog box may include a message that notifies Doug of the recommendation 210. Other ways of notifying Doug are broadly contemplated. For example, the application 150 may notify Doug of the recommendation 210 via Short Message Service (SMS), instant messaging (IM), etc.

To further illustrate embodiments of the invention, as shown in FIG. 2F, the application 150 may receive a recommendation 214 of a professional service—a dentist, Dr. Smith—from Bob. Because Alice has previously specified to follow Bob, the application 150 may notify Alice of the recommendation 214. For example, in response to a subsequent request from Alice for a personalized referrals feed, the application 150 may generate the personalized referrals feed (that includes the recommendation 214) and send it to Alice.

Similarly, as shown in FIG. 2G, the application 150 may receive a recommendation 218 of a business—a pet store named “Tim's Pets”—from Charlie. Because Alice and Doug have previously specified to follow Charlie, the application 150 may notify Alice and Doug of the recommendation 218. For example, in response to a subsequent request from Alice or Doug for a personalized referrals feed, the application 150 may generate the personalized referrals feed (that includes the recommendation 218) and send it to Alice or Doug.

As shown in FIG. 2H, the application 150 may receive a recommendation 224 of a professional service—an accountant named Jane White—from Doug. Because none of the other users (Alice, Bob, and Charlie) have specified to follow Doug, the application 150 does not notify any of the other users of the recommendation 224. For example, in response to a subsequent request from Alice, Bob, or Charlie for a personalized referrals feed, the application 150 may generate the personalized referrals feed (that does not include the recommendation 224) and send it to Alice, Bob, or Charlie.

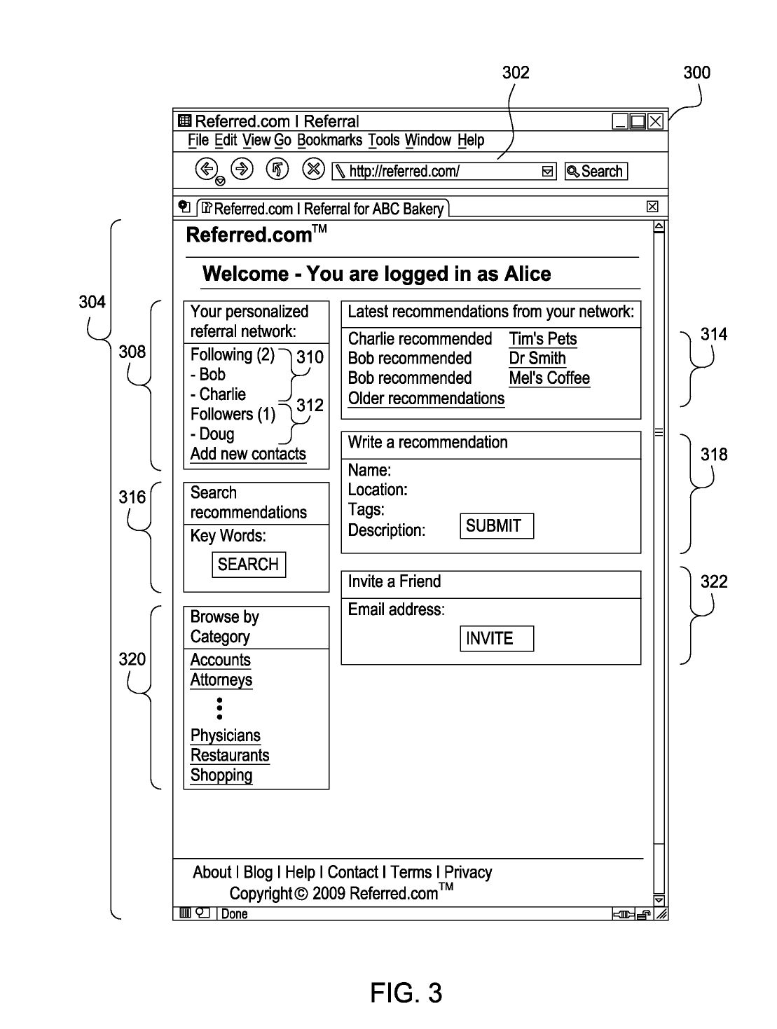

FIG. 3 illustrates a user interface (UI) screen 300 of the application 150, according to one embodiment of the invention. As shown, the UI screen 300 includes a URI 302 and page content 304. The page content 304 includes an indication 306 of a logged-in identity of the user (in this case, Alice) and the personalized referral network of the user 308. The personalized referral network of the user 308 may include a set 310 of users that Alice is following. The personalized referral network of the user 308 may also include a set 312 of users following Alice.

In one embodiment, the page content 304 may also include a personalized referrals feed 314 for Alice. The personalized referrals feed 314 may include recommendations from the personalized referral network of Alice. For example, in one embodiment, the personalized referrals feed 314 includes recommendations from the set 310 of users that Alice is following—and does not include any recommendations from the set 312 of users following Alice (unless Alice is also following the user).

As shown, the page content 304 also includes a search widget 316, a recommendation widget 318 and an invitation widget 322. The search widget 316 may generally be configured to allow the user to search recommendations based on one or more constraints. The constraints may include keywords, date of recommendation, geography, degree of separation in the social referral network, etc. For example, if Alice follows Bob, a single degree of separation is said to exist between Alice and Bob. If Doug now follows Alice, then two degrees of separation exist between Doug and Bob—a first degree between Doug and Alice and a second degree between Alice and Bob.

The recommendation widget 318 may allow the user to submit a new recommendation. For example, a user may supply a name of the recommended entity (e.g., business or professional service), a geographical location of the recommended entity, one or more tags for the recommended entity (e.g., “restaurant”, “physician”, “accountant”, etc.), and a description of the recommended entity. The geographical location may be a country, province, state, city, and/or street address of the recommended entity. The description may be a user-written review of the recommended entity.

The category widget 320 may allow users to browse recommendations based on categories that the recommendations pertain. The application 150 may generate the categories based on tags associated with the recommendations. For example, a “Physician” category may include recommendations having the “Doctor” tag or the “Physician” tag.

The invitation widget 322 may allow the user to invite new users to participate in the social referral network. For example, the user may input an email address of a friend or acquaintance into the invitation widget 322. And the he application 150 may send an email invitation to the friend or acquaintance to join the social referral network.

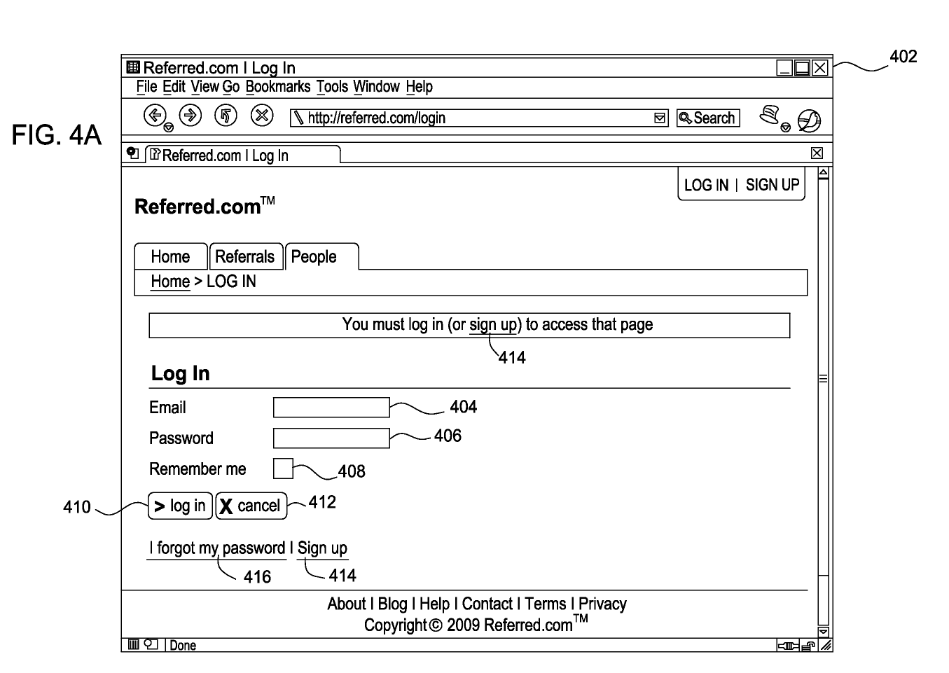

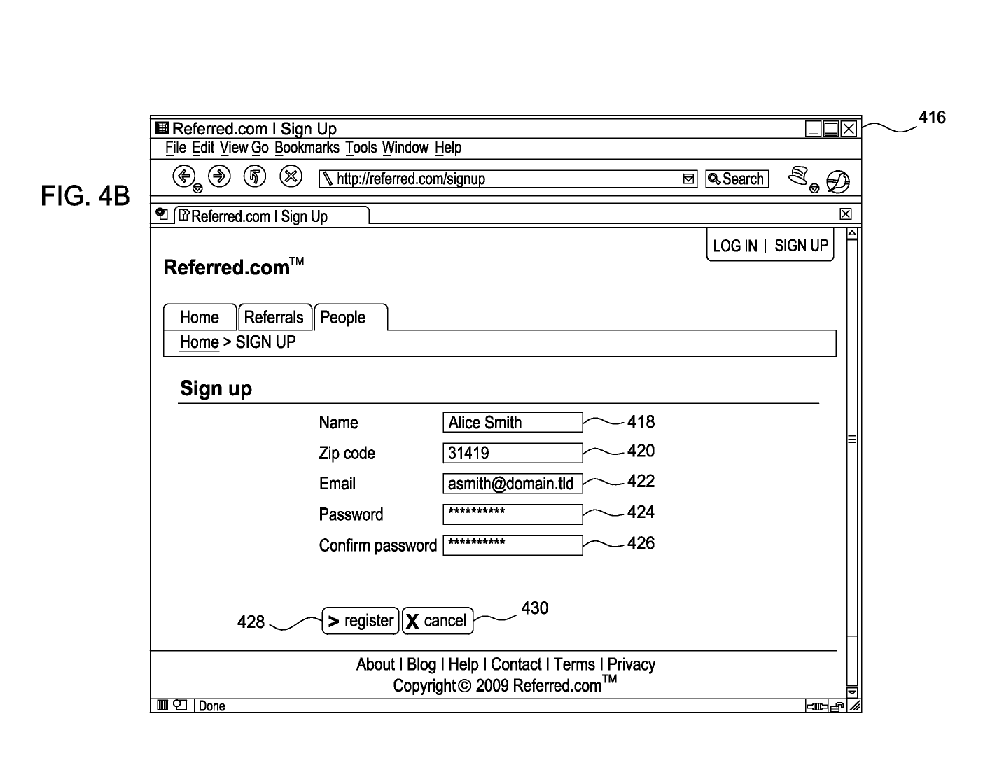

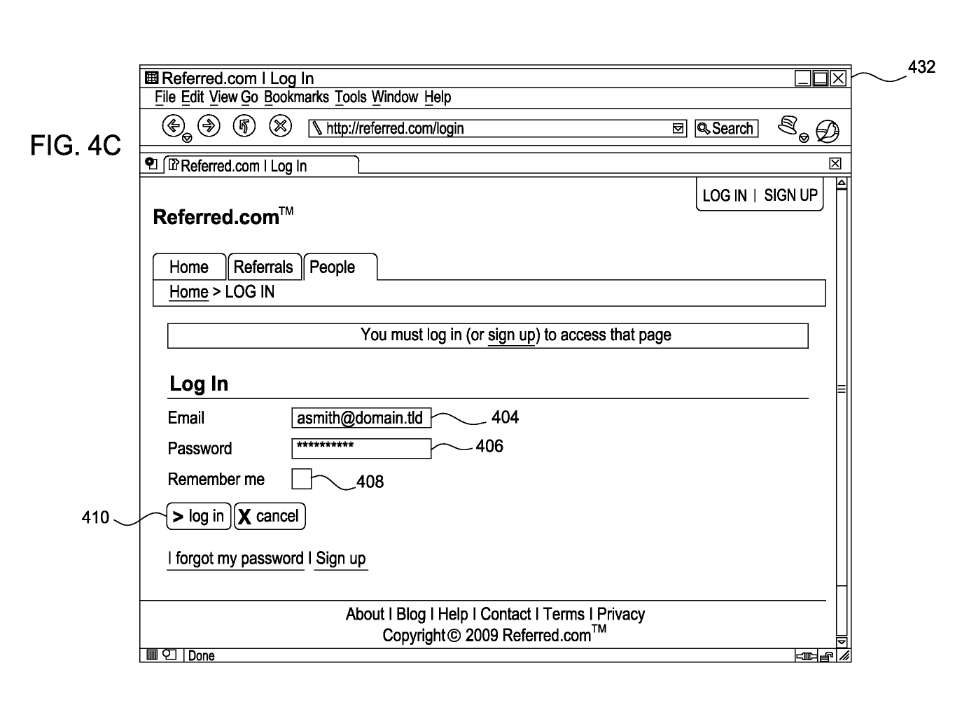

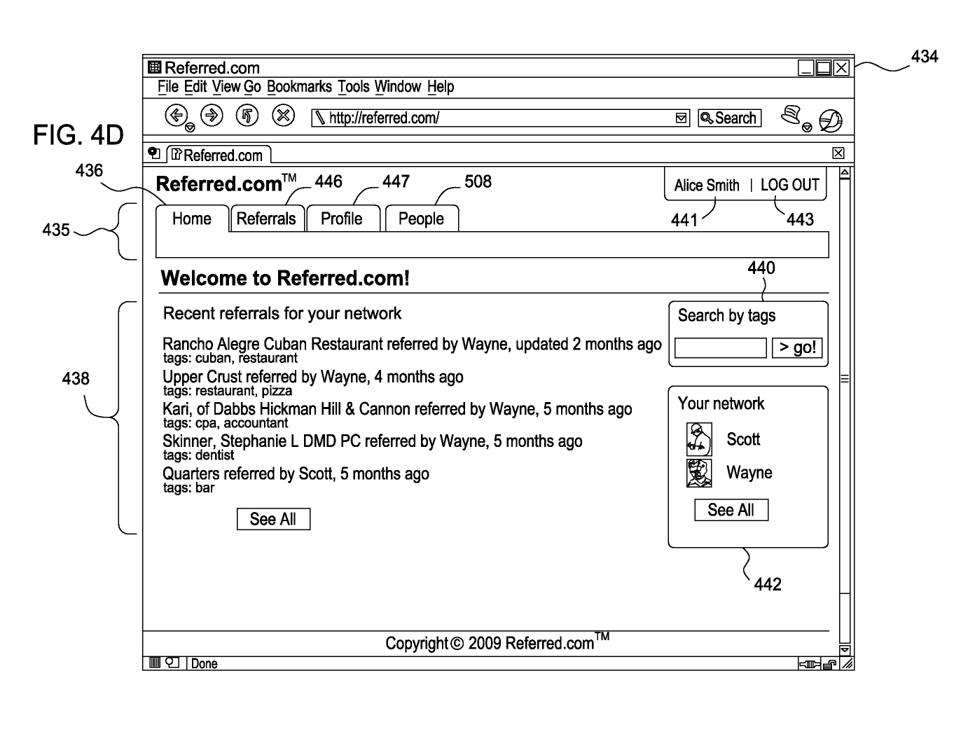

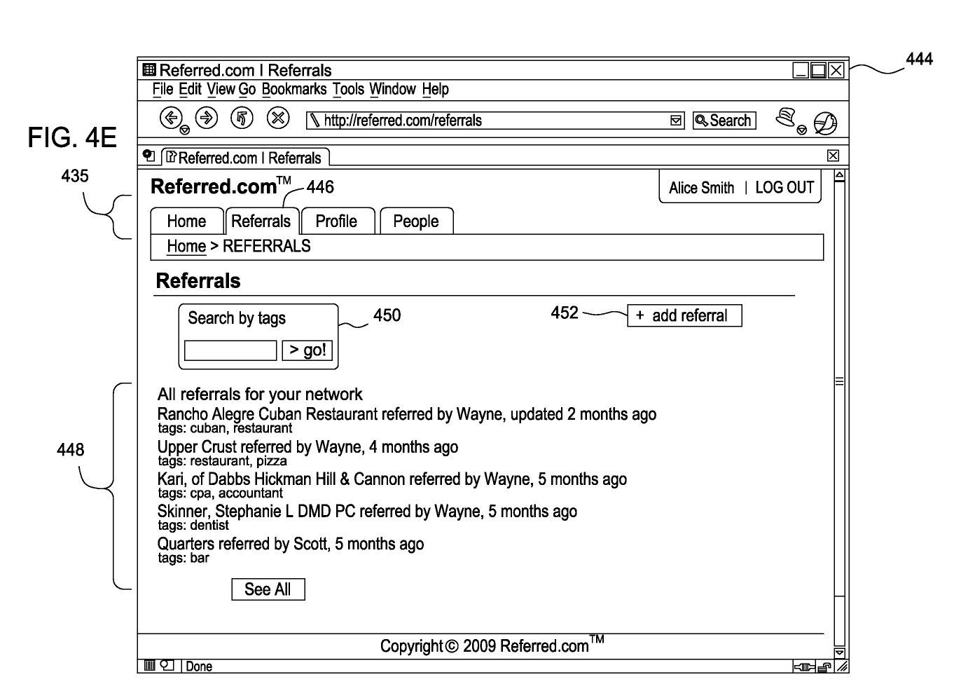

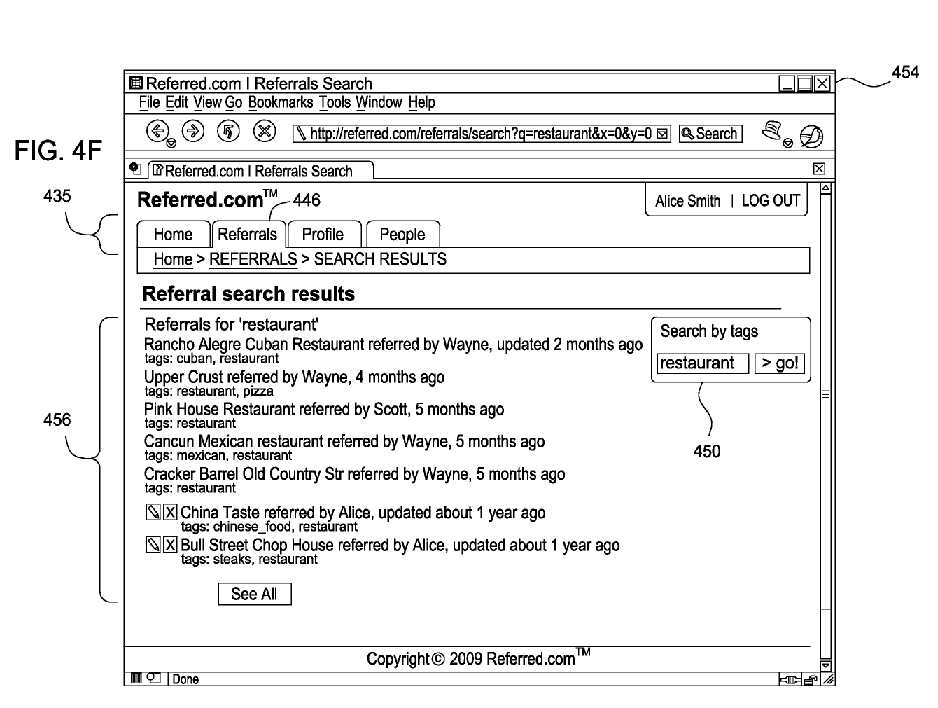

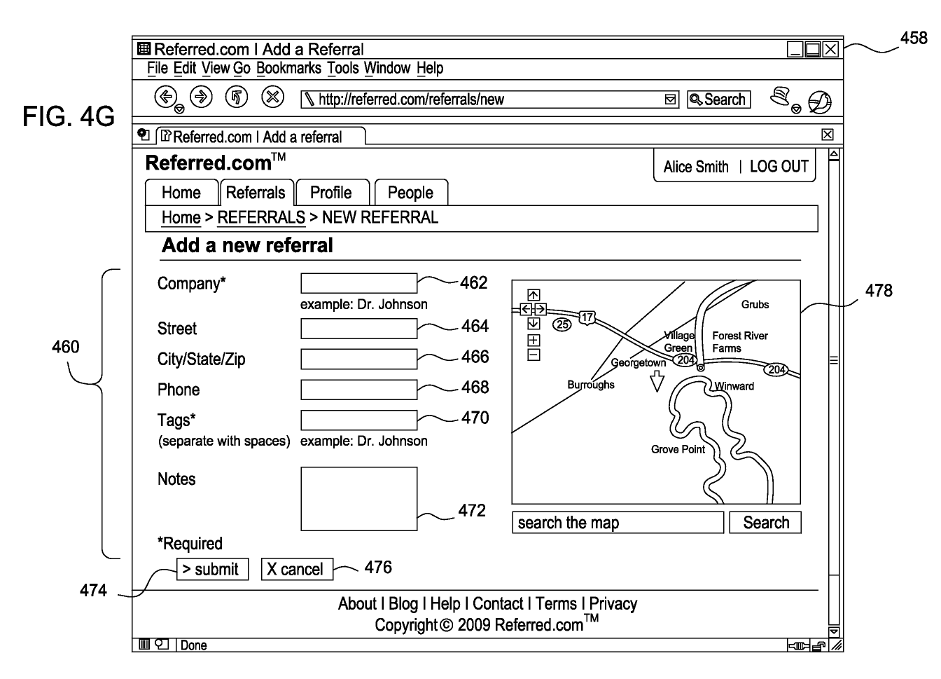

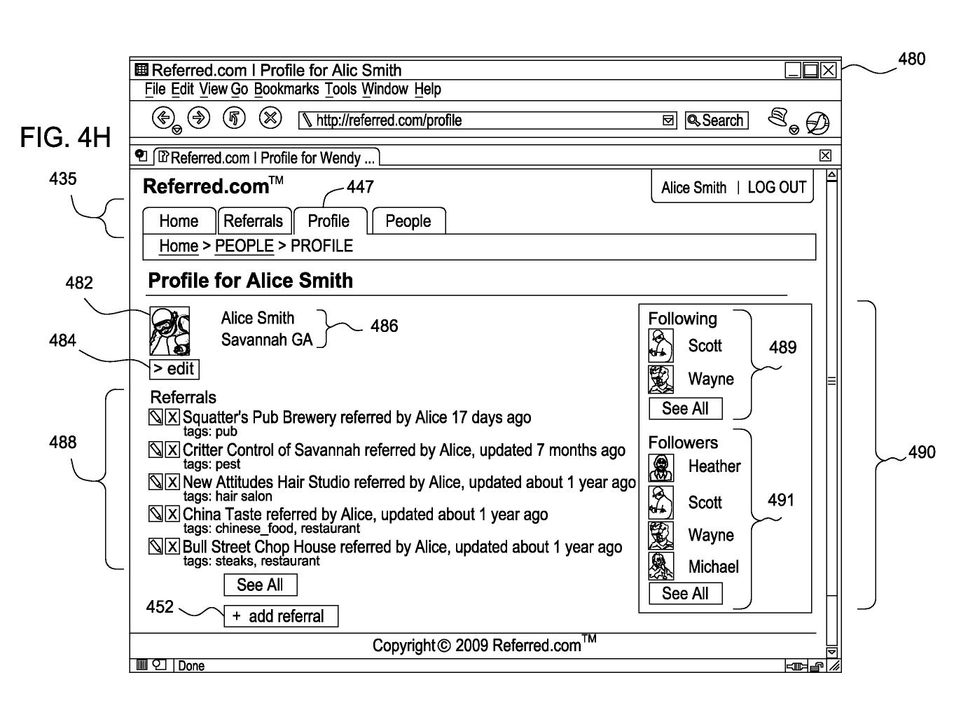

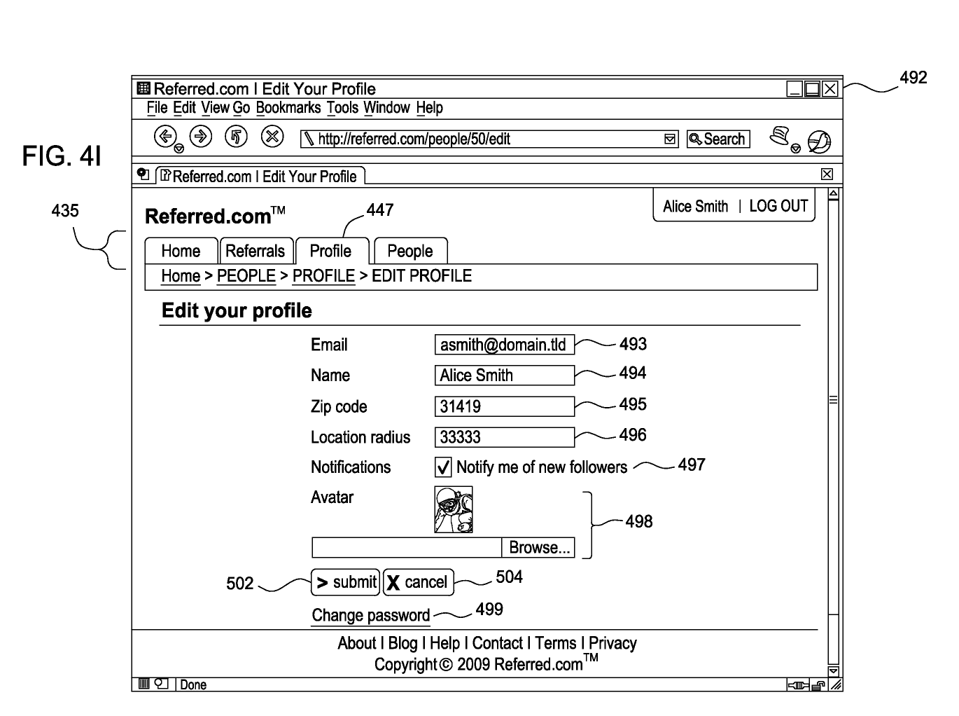

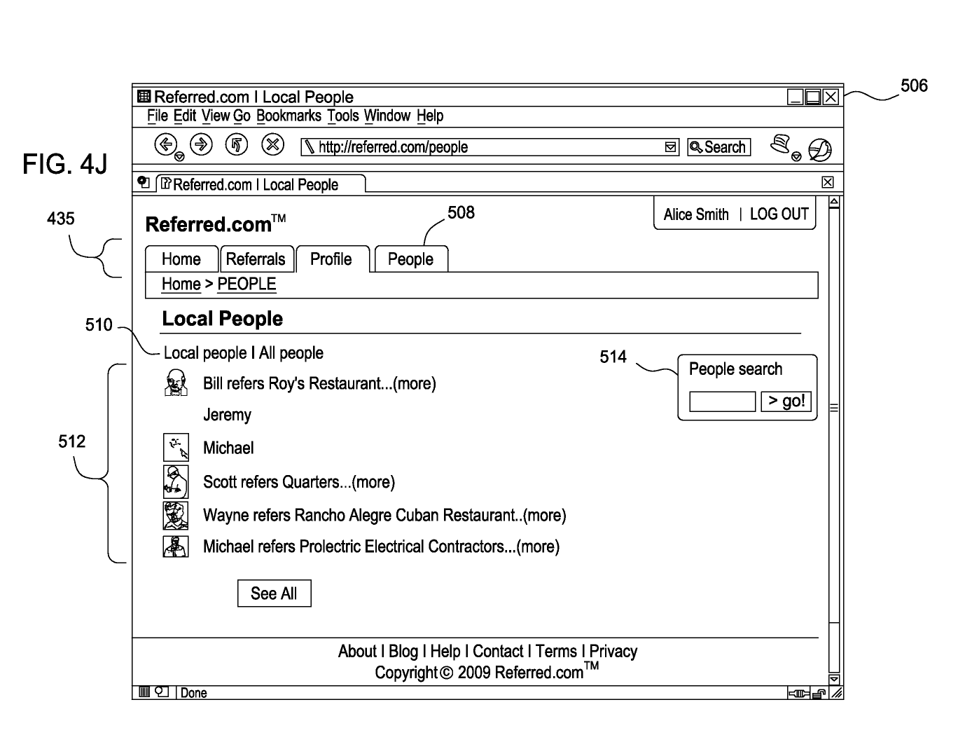

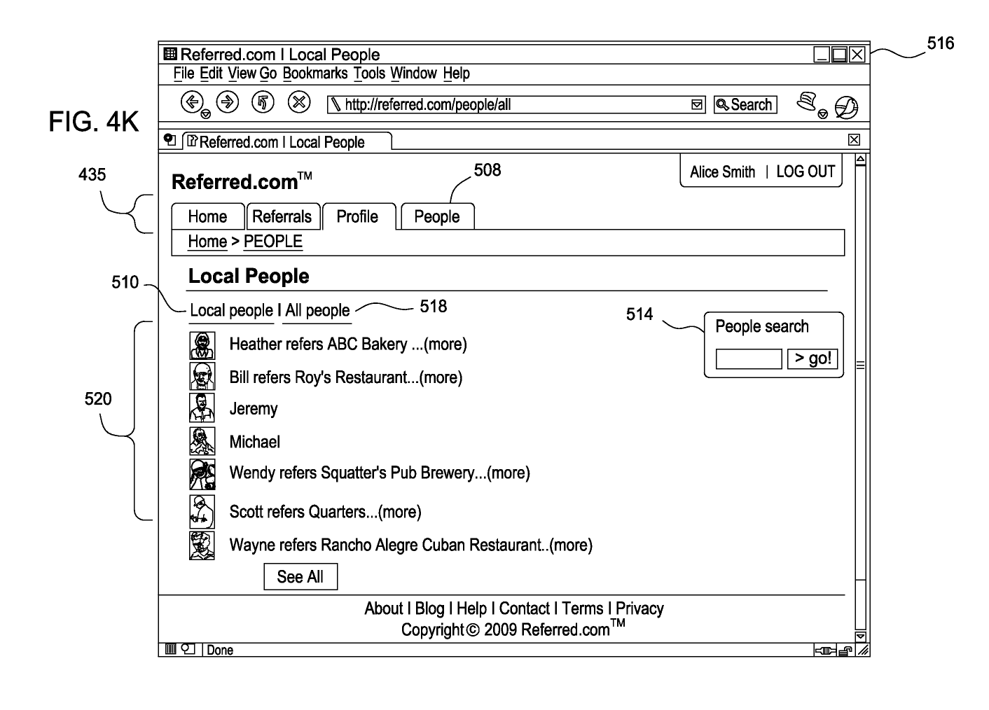

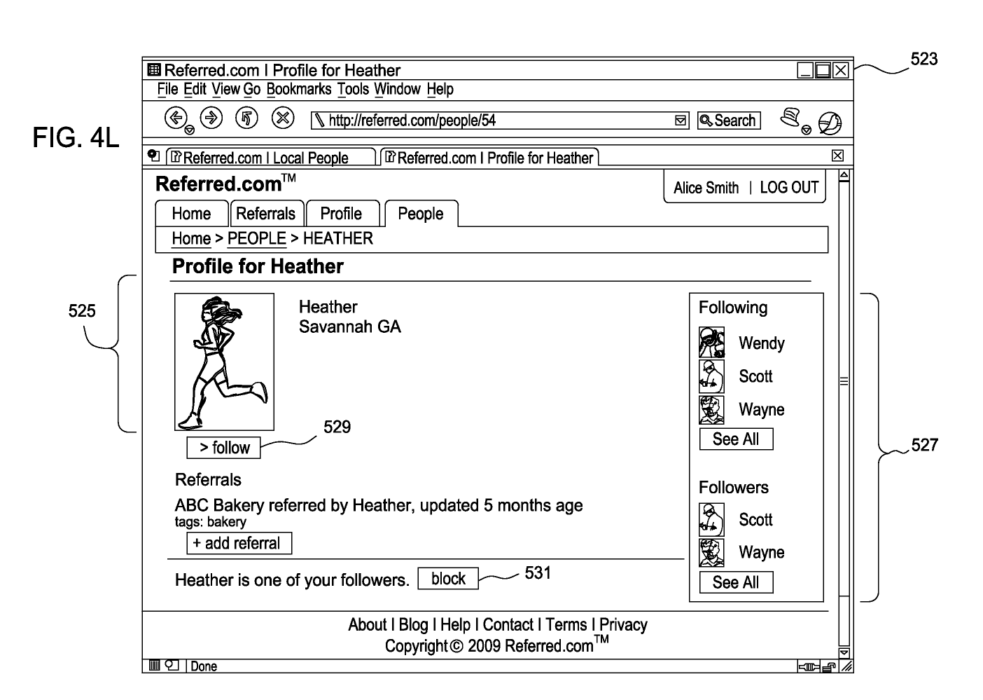

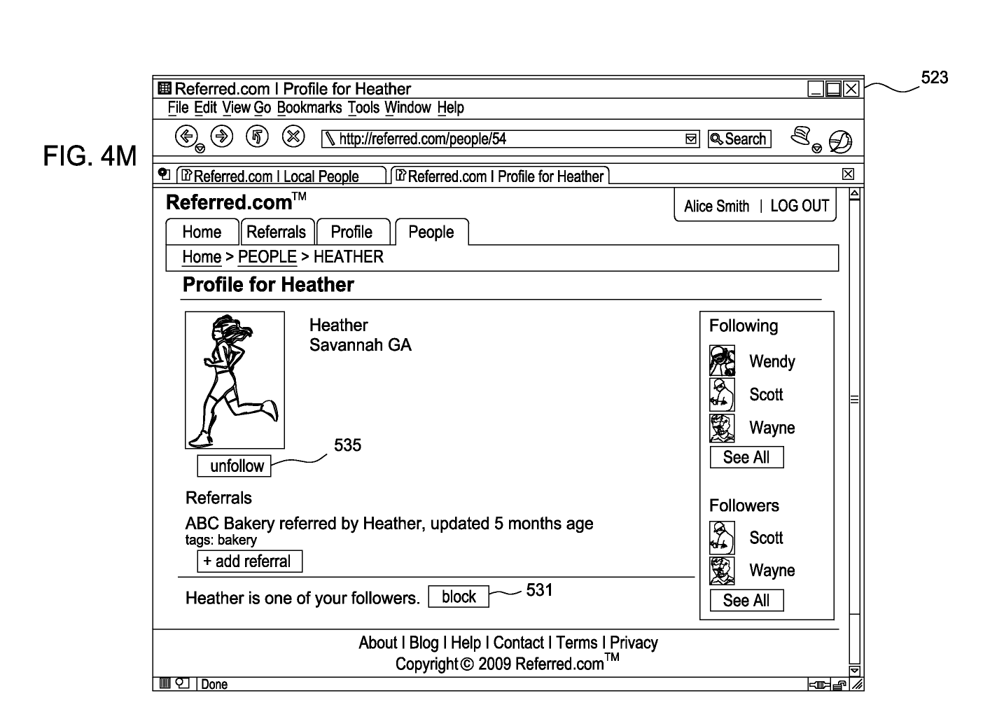

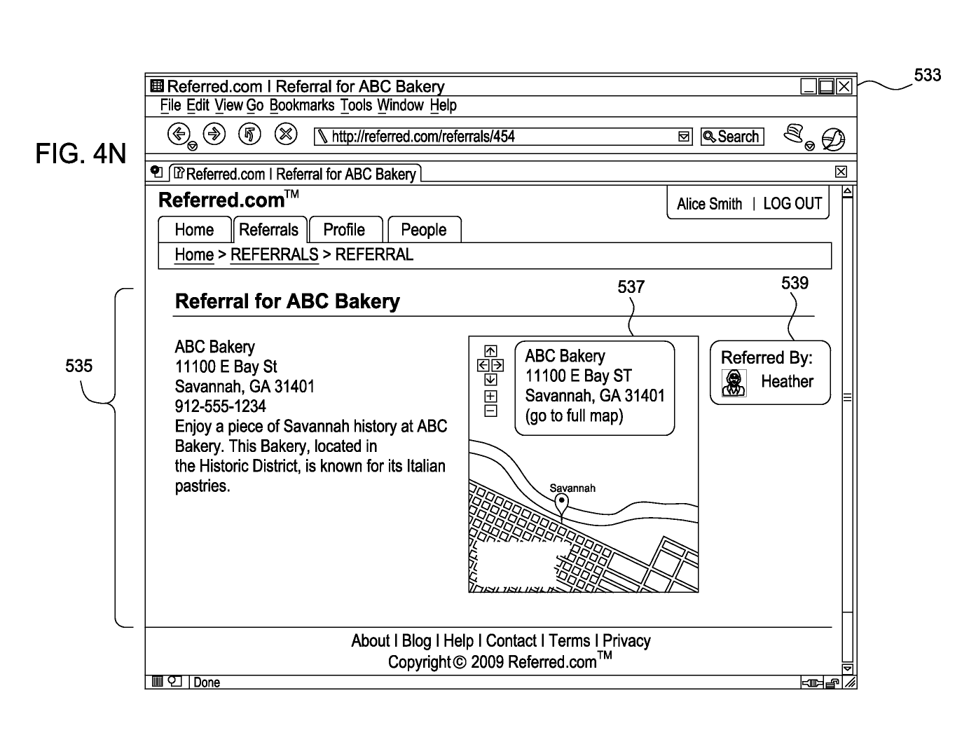

To further illustrate embodiments of the invention, FIGS. 4A-4M illustrate a collection of exemplary UI screens generated by the application 150, according to one embodiment of the invention. Note, although FIGS. 4A-4M show examples of an interface that might be presented on a personal computer (PC), embodiments of the invention may be adapted for use on other computing devices such as mobile phones, laptop computers, tablet computers, netbooks, pad computing devices, personal digital assistants (PDAs), and the like. In such cases, the interfaces provided by the server application 150 may be tailored for the particular client device of the user and by the server application 150 and/or by an application executing on the client device.

As shown in FIG. 4A, the application 150 presents a login screen 402 to the user. The login screen 402 may prompt the user to enter login information, such as an email address 404 and a password 406. The login screen 402 may include an option 408 to store identifying information of the user in a cookie on the computer of the user—to make subsequent logins by the user more convenient for the user (e.g., without requiring the user to go through the login screen 402 again—i.e., allowing the user to bypass the login screen 402). The login screen 402 may also include a link 416 to recover a forgotten password and a link 414 to sign up for a user account. The login screen 402 may a login button 410 for submitting a login request and a cancel button 412 for returning to a welcome page and/or splash screen of the application 150.

Assume that Alice is a new user signing up as a member of the social referral network. For example, Alice may click on the link 414 to sign up for a user account. In response, Alice may be presented with an account signup screen like the one shown in FIG. 4B. As shown in FIG. 4B, the account signup screen 416 includes a name field 418, a zip code field 420, an email address field 422, a password field 424, and a password confirmation field 426. The account signup screen 416 may also include a register button 428 and a cancel button 430. Alice may enter values for each field, e.g., “Alice Smith” for name, “31419” for zip code, “asmith@domain.tld” for email address, etc. Alice may then click on the register button 428 to submit the entered values. Alternatively, Alice may click on the cancel button 430 to return to the welcome page/splash screen of the application 150. To create a new user account, the application 150 may require the password field 424 to match the password confirmation field 426. The application 150 may also require Alice to click on a confirmation link or enter confirmation info from an email sent to Alice, in order to complete the registration process.

Once the registration process is completed, Alice may log in via the login screen 432 of FIG. 4C. As shown in FIG. 4C, Alice may input login information (e.g., the email address 404 and the password 406) associated with the new user account. Alice may then click on the login button 410 to submit the login information.

Once Alice is logged in, the application 150 may generate a home screen like the one shown in FIG. 4D. As shown in FIG. 4D, a home screen 434 may include a navigation widget 435. The navigation widget may include multiple tabs, each associated with a different screen of the application 150. In the particular example shown in FIG. 4D, the navigation widget includes a home tab 436, a referrals tab 446, a profile tab 447, and a people tab 508. The home tab 436 may be highlighted to indicate that the home screen 434 is the currently active screen. Alice may click on a specific tab to access the screen associated with the tab.

In one embodiment, the home screen 434 may include an indication of the logged-in user 441 and a link 443 to log out of the application 150. In this example, the logged-in user 441 is Alice Smith. The home screen 434 may also include a search widget 440 that allows Alice to search recommendations by tags. Assume that Alice has specified to follow several other users of the social referral network. That is, assume that the application 150 has already created a personalized referral network 442 for Alice at this point. In one embodiment, the home screen 434 may also include display the personalized referral network 442 of Alice. Further, the home screen 434 may include a listing 438 of recent recommendations from the personalized referral network of Alice. For example, the listing 438 of recommendations may include only recommendations submitted by users whom Alice has previously specified to follow.

Assume that multiple users have recommended the same business or professional service as part of their personalized referral network. In one embodiment, the application 150 may collapse recommendations from those users of the personalized referral network of Alice into a single (collapsed) recommendation. For example, assume that Alice is following Bob and Charlie but Alice is not following Doug. Assume that Bob, Charlie, and Doug each recommend the same business, “Tim's Pets”. In one embodiment, the personalized referrals feed of Alice may include the collapsed recommendation “Tim's Pets referred by Bob and Charlie.” That is, the personalized referrals feed includes the collapsed recommendation rather than two separate recommendations from Bob and Charlie, respectively. Further, because Alice has not specified to follow Doug, the collapsed recommendation does not indicate that Doug has also recommended Tim's Pets. Advantageously, Alice may more conveniently identify businesses or professional services that are recommended by multiple users in her personalized referral network. In one embodiment, Alice may also sort recommendations from her personalized referral network by a count of recommenders for each recommendation.

As described above, Alice may click on a specific tab of the navigation widget 435 to access the screen associated with the tab. For example, Alice may click on the referrals tab to access a referrals screen like the one shown in FIG. 4E. As shown in FIG. 4E, the referrals screen 444 may include a listing of all recommendations from the personalized referral network of Alice. The referrals screen 444 may also include a button 452 for adding a recommendation. Further, the referrals screen 444 may include a search widget 450 for searching recommendations by tag.

Referring now to FIG. 4F, assume that Alice desires to view restaurant recommendations from her personalized referral network. In one embodiment, Alice may submit the “restaurant” tag using the search widget 450. In response, the application 150 may output the recommendations 456 from her personalized referral network that match the “restaurant” tag. Advantageously, Alice may view recommendations of a specific type from her personalized referral network.

Referring back to FIG. 4E, assume Alice desires to add a new recommendation. In one embodiment, Alice may click on the button 452 to add a new recommendation. In response, the application 150 may generate a new recommendation screen like the one shown in FIG. 4G. As shown in FIG. 4G, a new recommendation screen 458 includes input fields 460 associated with the new recommendation. The input fields 460 include a business/professional service field 462, a street address field 464, a city/state/zip field 466, a telephone number field 468, a tags field 470, and a notes field 472. Alice may input multiple tags separated by a delimiter character (e.g., a comma or a space) in the tags field 470. And Alice may input a user review of the business or professional service in the notes field 472. The new recommendation screen 458 may also include a map widget 478 for looking up a street address of a recommended entity using the name of the recommended entity. Further, the new recommendation screen 458 may include a submit button 474 and a cancel button 476. Alice may click on the submit button 474 to submit the new recommendation. Alternatively, Alice may click on the cancel 476 button to return to the referrals screen 444 of FIG. 4E.

Assume that Alice has previously uploaded an avatar to her user profile. Referring now to FIG. 4H, suppose that Alice desires to view her user profile in the social referral network. In one embodiment, Alice may click on the profile tab 447 of the navigation widget 435. In response, the application 150 may generate the user profile screen like the one shown in FIG. 4H. As shown, the user profile screen 480 includes information 486 associated with Alice. The information may include a name, a city and a state. The user profile screen 480 may also include the avatar 482 of Alice. Further, the user profile screen 480 may include a listing 488 of recommendations previously submitted by Alice. The user profile screen 480 may also include the personalized referral network 490 for Alice, which may include a list 491 of users following Alice and a list 489 of users whom Alice is following. The user profile screen 480 may also include a button 452 for adding a new recommendation. Further, the user profile screen 480 may include a button 484 for editing the user profile.

Assume that Alice desires to edit her user profile in the social referral network. In one embodiment, Alice may click on the button 484 for editing the user profile. In response, the application 150 may generate an edit profile screen like the one shown in FIG. 41. As shown in FIG. 41, via the edit profile screen 492, Alice may edit information contained in her profile. For example, Alice may edit the email address 493, the name 494, the zip code 495, the location radius 496, and/or the avatar 498. When generating a listing of recommendations based on the zip code 495, the application 150 may include (or exclude) recommendations (and/or other users) based on the location radius 496. As such, the location radius 496 may specify that only recommended entities having a street address (and/or other users having a zip code) within the location radius 496 (e.g., 33333 feet, or approximately 6.31 miles) of the zip code 495 (of “31419”) are displayed. Alice may click on the submit button 502 to submit the changes. Alternatively, Alice may click on the cancel button 504 to return to the user profile screen 480. If Alice desires to change the password on her user account, Alice may click on the link 499 for changing the user password.

Referring now to FIG. 4J, assume that Alice desires to view other users of the application 150 that are local to the location of Alice. In one embodiment, Alice may click on the people tab 508 of the navigation widget 435. In response, the application 150 may generate a UI screen like the one shown in FIG. 4J. As shown, a UI screen 506 includes a listing 512 of local users. The listing 512 of local users includes users having a zip code within 6.31 miles of the zip code “31419” (as specified in the user profile of Alice). The UI screen 506 may also include a user search widget 514. Alice may search for a specific user using the user search widget 514, e.g., by inputting a first name, last name, zip code, email address, etc. In response, the application 150 may generate a new listing of local users who satisfy the constraints submitted via the user search widget 514. Further, the listing 512 of local users may also include recommendations made by the local users. In one embodiment, the UI screen 506 of FIG. 4J (i.e., corresponding to the people tab 508) may display recommendations in a different manner than would the referrals screen 444 of FIG. 4E (i.e., corresponding to the referrals tab 446). For example, the UI screen 506 for the people tab 508 may output a recommendation in a first format that emphasizes the recommending user, e.g., “Heather refers ABC Bakery”. In contrast, the referrals screen 506 for the referrals tab 446 may output the recommendation in a second format that emphasizes the recommended entity, e.g., “ABC Bakery referred by Heather.” While the foregoing example uses prose with active voice and passive voice, respectively, for emphasis, other ways of emphasizing the recommending user and/or the recommended entity are broadly contemplated. For example, in an alternative embodiment, the recommending user or the recommended entity may be highlighted, underlined, italicized, etc.

Assume that Alice desires to view other users of the application 150, regardless of geographical location of the other users. In one embodiment, Alice may click on the “all people” link 518 of FIG. 4J. In response, the application 150 may generate a UI screen like the one shown in FIG. 4K. As shown in FIG. 4K, a UI screen 516 includes a global listing 520 of users. The global listing 520 of users includes all users of the application 150—regardless of whether each user is a member of the personalized referral network of Alice. The UI screen 516 also includes the search widget 514. As described above, Alice may search for a specific user using the user search widget 514, e.g., by inputting a first name, last name, zip code, email address, etc. In response, the application 150 may generate a new listing of global users who satisfy the constraints submitted via the user search widget 514. Alice may also click on the “local people” link 510 to return to the listing of local users.

Referring now to FIG. 4L, assume that Alice desires to view the profile of a specific user from the listing of local users (of FIG. 4J) or from the global listing of users (of FIG. 4K). In one embodiment, Alice may click on the name or avatar of the user in the listing. In response, the application 150 may generate a user profile screen like the one shown in FIG. 4L. Suppose Alice clicks on Heather from the global listing of users. As shown, a user profile screen 523 for Heather includes information associated with the user account of Heather. The information may include an avatar, a name, a city, a state, etc. The user profile screen 523 for Heather may also include a follow button 529. If Alice desires to follow Heather, Alice may click on the follow button 529. In response, the application 150 may update the personalized referral network of Alice to include Heather as a user whom Alice is following. Subsequently, if Alice desires to stop following Heather, Alice may click on an “unfollow” button 535 like the one shown in FIG. 4M. In response, the application 150 may update the personalized referral network of Alice to remove Heather as a user whom Alice is following. Further, if Heather is following Alice, Alice may click on a block button 531 to stop Heather from following Alice and/or to prevent Heather from subsequently following Alice ever again. Alice may also click on an “unblock button” (not shown) to allow Heather to follow Alice once again. Advantageously, Alice may conveniently customize the personalized referral network of Alice—and thereby also customize the personalized referrals feed of Alice. For example, Alice may customize the personalized referrals feed of Alice to include recommendations from only the users whom Alice trusts most.

Referring back to FIG. 4K, although the global listing 520 of users may also include recommendations, the global listing 520 of users may not necessarily include recommendations in their entirety (e.g., to avoid cluttering the display of the global listing 520). That is, the global listing 520 of users may include recommendations in an abridged form. Assume that Alice desires to view a full recommendation from the global listing 520 of users. In one embodiment, Alice may click on a name of a recommended entity (e.g., “ABC Bakery”) in the global listing 520 of users. In response, the application 150 may generate a referral screen like the one shown in FIG. 4N. As shown, a referral screen 533 includes information associated with a recommended entity. The information may include the name of the recommended entity, the telephone number of the recommended entity, the address of the recommended entity, tags associated with the recommended entity, a description of the recommended entity, a map 537 of the recommended entity, and a list 539 of users who have recommended the entity. That is, the referral screen 533 provides Alice with the full recommendation of a selected entity.

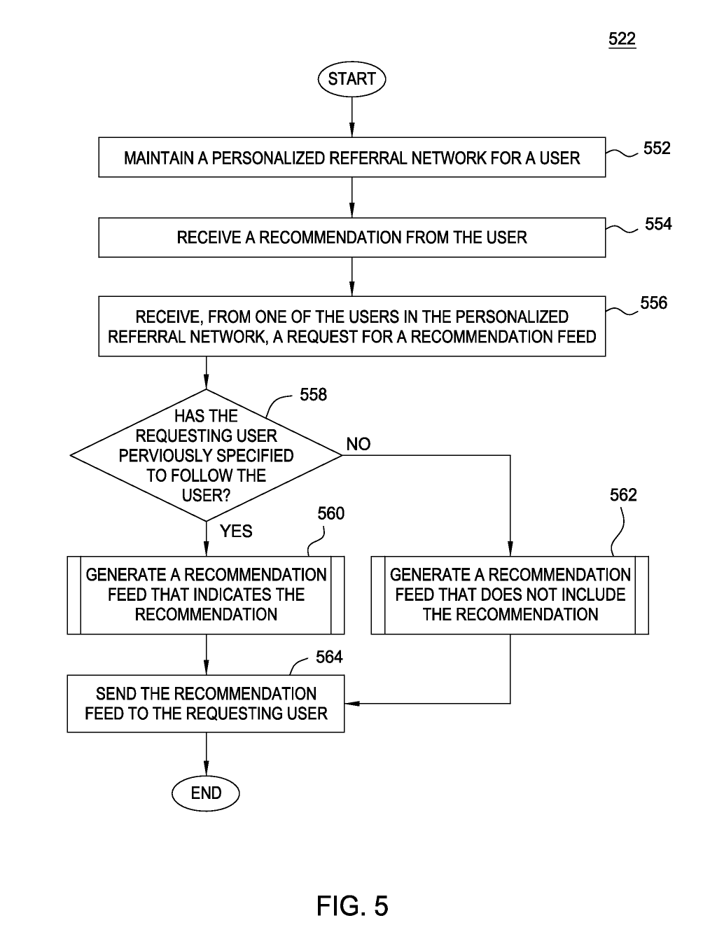

FIG. 5 is a flow diagram depicting a method 550 for sending a recommendation from a personalized referral network to a user, according to one embodiment of the invention. As shown, the method 550 begins at step 552, where the application 150 maintains a personalized referral network for the user. As described above, the personalized referral network for the user may include a list of other users following the user and a list of other users followed by the user. At step 554, the application 150 receives a recommendation from the user. For example Alice may recommend a restaurant, “Sam's Grill” (e.g., as shown in FIG. 2E). At step 556, the application 150 receives, from one of the users in the personalized referral network, a request for a recommendation feed. For example, assuming Doug is a member of the personalized referral network of Alice, Doug requests a recommendation feed from the application 150.

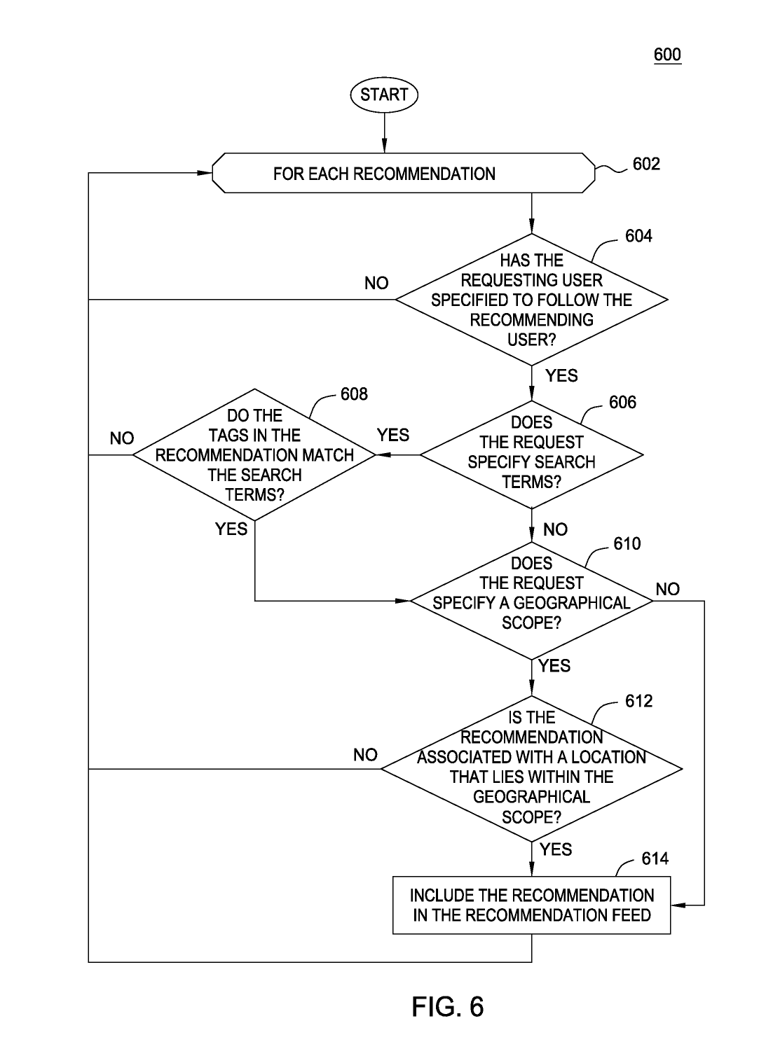

At step 558, the application 150 determines whether the requesting user has previously specified to follow the user. For example, the application 150 determines whether Doug has previously specified to follow Alice. If so, the application 150 generates a recommendation feed that includes the recommendation from Alice (step 560). Otherwise, the application 150 generates a recommendation feed that does not include the recommendation from Alice (step 562). The steps 560 and 562 are further described below in conjunction with FIG. 6. After the step 560 or the step 562, the method proceeds to step 564, where the application 150 sends the recommendation feed to the requested user (e.g., Doug). After the step 564, the method 550 terminates.

FIG. 6 is a flow diagram depicting a method 600 for generating the recommendation feed, according to one embodiment of the invention. The steps of the method 600 may correspond to the step 560 or the step 562 of FIG. 5. As shown in FIG. 6, the method 600 begins at step 602, where the application 150 enters a loop for each recommendation previously received by the application 150. Of course, other embodiments are broadly contemplated. For example, in an alternative embodiment, the application 150 may loop through a list of users followed by the requesting user—rather than loop through a global list of all recommendations—to generate the recommendation feed more efficiently.

At step 604, the application 150 determines whether the requesting user has specified to follow the recommending user, i.e., the user who has submitted the respective recommendation. If not, the method returns to the step 602 to process a next recommendation. At step 606, the application 150 determines whether the request (for the personalized referral feed) specifies any tags. If so, the application 150 determines whether the respective recommendation match the tags to an acceptable extent—e.g., all the tags or a minimum threshold number of the tags, as specified by the requesting user, by the application 150, or by the recommending user. If the respective recommendation does not match the tags to the acceptable extent, the method returns to the step 602 to process the next recommendation.

At step 610, the application 150 determines whether the request (for the personalized referral feed) specifies a geographical scope. If so, the application 150 determines whether the recommended entity (of the respective recommendation) exists within the specified geographical scope (e.g., based on the street address of the recommended entity). If the recommended entity does not exist within the specified geographical scope, the method returns to the step 602 to process the next recommendation.

On the other hand, if the request does not specify any geographical scope, or if the recommended entity exists within the specified geographical scope, the application 150 includes the respective recommendation in the recommendation feed (step 614). After the step 614, the application 150 returns to the step 602 to process the next recommendation. After all recommendations are processed from the loop 602, the method 600 terminates.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Advantageously, embodiments of the invention provide techniques for maintaining a personalized referral network for a user. The user may browse businesses and/or professional services recommended by other users of the personalized referral network. The user may also manage the personalized referral network to control what recommendations appear in a personalized recommendations feed for the user. Advantageously, the user may more conveniently receive recommendations that are responsive to the needs of the user.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
providing a social business referral service that includes asymmetric relationships between users, comprising:
receiving a request from a first user to be notified of any business entity referred by a second user; and
storing, responsive to the request and in a referral network associated with the first user, an indication to notify the first user of business entities referred by the second user; and
receiving, from the second user, an indication of a referred business entity; and
notifying the first user that the second user has referred the business entity, on the basis of the stored indication to notify the first user of business entities referred by the second user and by operation of one or more computer processors.

2. The computer-implemented method of claim 1, wherein the second user has previously referred at least one additional business entity other than the referred business entity, and wherein providing the social business referral service further comprises:
notifying the first user that the second user has previously referred the at least one additional business entity, on the basis of the stored indication to notify the first user of business entities referred by the second user.

3. The computer-implemented method of claim 1, wherein each indication of a referred business entity comprises a name of the referred business entity, a location of the referred business entity, and one or more tags characterizing the referred business entity.

4. The computer-implemented method of claim 1, wherein the second user has not previously requested to be notified of any business entity referred by the first user, and wherein providing the social business referral service further comprises:
receiving, from the first user, an indication of a second referred business entity;
wherein the second user is not notified that the first user has referred the second business entity, on the basis of the second user not having previously requested to be notified of any business entity referred by the first user and despite the stored indication to notify the first user of business entities referred by the second user.

5. The computer-implemented method of claim 1, wherein providing the social business referral service further comprises:
receiving a request from a third user to be notified of any business entity referred by the first user;
storing, responsive to the request and in the referral network, an indication to notify the first user of business entities referred by the second user;
receiving, from the first user, an indication of a second referred business entity; and
notifying the third user that the first user has referred the second business entity, on the basis of the stored indication to notify the third user of business entities referred by the first user.

6. The computer-implemented method of claim 1, wherein providing the social business referral service further comprises:
receiving a request from the first user to cease being notified of any business entity referred by the second user; and
removing, from the referral network and responsive to the request to cease being notified, the stored indication to notify the first user of business entities referred by the second user.

7. The computer-implemented method of claim 1, wherein providing the social business referral service further comprises:
receiving a request from the second user to cease notifying the first user of any business entity referred by the second user;
removing, from the referral network and responsive to the request to cease notifying the first user, the stored indication to notify the first user of business entities referred by the second user; and
storing, in the referral network and responsive to the request to cease notifying the first user, an indication that the first user may no longer request to be notified of business entities referred by the second user.

8. The computer-implemented method of claim 1, wherein each business entity comprises a brick-and-mortar business entity, and wherein providing the social business referral service:
receiving, from the first user, a request to search for referred business entities satisfying specified criteria comprising at least one tag and a geographical scope; and
upon determining that the business entity satisfies the specified criteria and on the basis of the stored indication to notify the first user of business entities referred by the second user, notifying the first user that the second user has referred the business entity.

9. A computer-readable storage medium containing a program which, when executed, performs an operation comprising:
providing a social business referral service that includes asymmetric relationships between users, comprising:
receiving a request from a first user to be notified of any business entity referred by a second user; and
storing, responsive to the request and in a referral network associated with the first user, an indication to notify the first user of business entities referred by the second user; and
receiving, from the second user, an indication of a referred business entity; and
notifying the first user that the second user has referred the business entity, on the basis of the stored indication to notify the first user of business entities referred by the second user.

10. The computer-readable storage medium of claim 9, wherein the second user has previously referred at least one additional business entity other than the referred business entity, and wherein providing the social business referral service further comprises:
notifying the first user that the second user has previously referred the at least one additional business entity, on the basis of the stored indication to notify the first user of business entities referred by the second user.

11. The computer-readable storage medium of claim 9, wherein each indication of a referred business entity comprises a name of the referred business entity, a location of the referred business entity, and one or more tags characterizing the referred business entity.

12. The computer-readable storage medium of claim 9, wherein the second user has not previously requested to be notified of any business entity referred by the first user, and wherein providing the social business referral service further comprises:
receiving, from the first user, an indication of a second referred business entity; wherein the second user is not notified that the first user has referred the second business entity, on the basis of the second user not having previously requested to be notified of any business entity referred by the first user and despite the stored indication to notify the first user of business entities referred by the second user.

13. The computer-readable storage medium of claim 9, wherein providing the social business referral service further comprises:
receiving a request from a third user to be notified of any business entity referred by the first user;
storing, responsive to the request and in the referral network, an indication to notify the third user of business entities referred by the first user;
receiving, from the first user, an indication of a second referred business entity; and
notifying the third user that the first user has referred the second business entity, on the basis of the stored indication to notify the third user of business entities referred by the first user.

14. The computer-readable storage medium of claim 9, wherein providing the social business referral service further comprises:
receiving a request from the first user to cease being notified of any business entity referred by the second user; and
removing, from the referral network and responsive to the request to cease being notified, the stored indication to notify the first user of business entities referred by the second user.

15. A system, comprising:
one or more computer processors;
a memory containing a program which, when executed by the one or more computer processors, performs an operation comprising:
providing a social business referral service that includes asymmetric relationships between users, comprising:
receiving a request from a first user to be notified of any business entity referred by a second user; and
storing, responsive to the request and in a referral network associated with the first user, an indication to notify the first user of business entities referred by the second user; and
receiving, from the second user, an indication of a referred business entity; and
notifying the first user that the second user has referred the business entity, on the basis of the stored indication to notify the first user of business entities referred by the second user.

16. The system of claim 15, wherein the second user has previously referred at least one additional business entity other than the referred business entity, and wherein providing the social business referral service further comprises:
notifying the first user that the second user has previously referred the at least one additional business entity, on the basis of the stored indication to notify the first user of business entities referred by the second user.

17. The system of claim 15, wherein each indication of a referred business entity comprises a name of the referred business entity, a location of the referred business entity, and one or more tags characterizing the referred business entity.

18. The system of claim 15, wherein the second user has not previously requested to be notified of any business entity referred by the first user, and wherein providing the social business referral service further comprises:
receiving, from the first user, an indication of a second referred business entity;
wherein the second user is not notified that the first user has referred the second business entity, on the basis of the second user not having previously requested to be notified of any business entity referred by the first user and despite the stored indication to notify the first user of business entities referred by the second user.

19. The system of claim 15, wherein providing the social business referral service further comprises:
receiving a request from a third user to be notified of any business entity referred by the first user;
storing, responsive to the request and in the referral network, an indication to notify the third user of business entities referred by the first user;
receiving, from the first user, an indication of a second referred business entity; and
notifying the third user that the first user has referred the second business entity, on the basis of the stored indication to notify the third user of business entities referred by the first user.

20. The system of claim 15, wherein providing the social business referral service further comprises:
receiving a request from the first user to cease being notified of any business entity referred by the second user; and
removing, from the referral network and responsive to the request to cease being notified, the stored indication to notify the third user of business entities referred by the first user.
